(19) United States
(12) Patent Application Publication
(10) Pub. No.: US 2024/0276994 A1
(43) Pub. Date: Aug. 22, 2024

(54) POULTRY MARKING EQUIPMENT AND METHODS

(71) Applicant: Cargill, Incorporated, Wayzata, MN (US)

(72) Inventors: Carolina Bolaños Alfaro, San Miguel (CR); Kira Hasbun Chavarría, San José (CR); Michael Herrera Castro, San Rafael (CR); Ricardo Paniagua Marin, Alajuela (CR)

(73) Assignee: Cargill, Incorporated, Wayzata, MN (US)

(21) Appl. No.: 18/572,012

(22) PCT Filed: Jun. 30, 2022
(86) PCT No.: PCT/US2022/073298

§ 371 Date: Dec. 19, 2023

Related U.S. Application Data
(60) Provisional application No. 63/216,757, filed on Jun. 30, 2021.

(51) Int. Cl. A22C 17/10

(52) U.S. Cl. CPC A22C 17/10

(57) ABSTRACT

A method of branding indicia onto an outer surface of at least one food item, including the steps of: positioning at least one food item on a top surface of a conveyor, conveying food item(s) toward a branding station comprising a laser, wherein the branding station comprises an upper member spaced from the top surface of the conveyor, and wherein the upper member comprises an aperture; conveying food item(s) into the space between the upper member and the top surface of the conveyor; and branding indicia onto the outer surface of the food item(s) with the laser through the aperture.

### CROSS-REFERENCE TO RELATED APPLICATIONS

This application claims the benefit of U.S. Provisional Patent Application No. 63/216,757, filed 30 Jun. 2021, which is hereby incorporated by reference in its entirety.

### TECHNICAL FIELD

The present disclosure generally relates to equipment and methods for applying markings to an outer surface of a food product, and more specifically relates to equipment and methods for marking or branding indicia on an outer surface of poultry as it is being processed.

### BACKGROUND

It is often important to consumers to be able to identify the source of food products at the point of purchase, and it is common to provide such identification in the form of packaging materials in which the food products are enclosed. For one example, food items such as chicken nuggets and chicken strips can be processed, frozen, and packaged in a bag. The bag may include pre-printed information on its outer surface, including a list of ingredients, instructions for cooking the enclosed products, and information regarding the source of the food items. For another example, food can be processed on-site and then packaged for sale, such as at a grocery store where meat is ground or otherwise processed prior to packaging. The food items can then be placed into packaged and labeled with information such as the date of packaging, store information, and the weight of the contents.

In some situations, however, large volumes of food items are provided in bulk to a retail location where the food items are removed from their packaging and placed in a location with other similar food items, some of which may be provided by a different source. Once such food items are separated from their packaging, it may be difficult or impossible for a consumer to identify the source of the food items. As an example, whole chickens can be provided in a bulk form and placed into bins or cases from which a consumer can choose a particular chicken for purchase. Because there is no identifying information on these chickens, it can be difficult or impossible for the consumer to determine the source of the chicken.

Although some consumers are satisfied with purchasing food items without knowing their source, there is a desire in many circumstances to be able to mark or label food items (e.g., poultry) on the items themselves so that consumers can easily identify their source. Such marking or labeling would desirably not impact the taste and/or quality of the food items and should be durable enough to withstand product handling without significant deterioration of the mark.

### SUMMARY

Aspects of the invention described herein are directed to marking equipment and methods that can be used for food products, such as poultry. Such marking equipment can include lasers that are designed for “branding” or marking information onto the outer surface or skin of the poultry during the processing of same. The brand or mark may include information that identifies the source of the poultry and/or provides other indicia, logos, names, images, or designs.

In an aspect of the invention, a method of branding indicia onto an outer surface of at least one food item is described, which includes the steps of: positioning at least one food item on a top surface of a conveyor, conveying food item(s) toward a branding station comprising a laser, wherein the branding station comprises an upper member spaced from the top surface of the conveyor, and wherein the upper member comprises an aperture: conveying food item(s) into the space between the upper member and the top surface of the conveyor; and branding indicia onto the outer surface of the food item(s) with the laser through the aperture. The method may also include a step of preparing the food items for marking by reducing the moisture on the outer surface of the food items. This may be accomplished through the use of a blowing apparatus or station that directs air at the food items to remove any residual fluid droplets that might interfere with the marking process.

The method of branding indicia may be used for poultry items, for example. The step of conveying the food item(s) may include conveying at a speed that allows indicia to be branded on the outer surface of the food item(s) without stopping, while at the same time allows the laser to recover for the next mark, or may include periodically pausing the conveyor to allow indicia to be branded on the outer surface of the food item. The food item(s) may each be positioned in a predetermined location on the top surface of the conveyor. The method may further include a step of determining a height of each food item and then adjusting the position of the upper member of the branding station relative to the outer surface of the food item prior to branding indicia onto the outer surface

In another aspect of the invention, a method of branding indicia onto an outer surface of at least one food item is described, which includes the steps of: attaching at least one food item to a horizontal movement mechanism: moving the food item(s) in a generally horizontal direction toward a branding station comprising a laser; and branding indicia onto the outer surface of the food item(s) with the laser. The horizontal movement mechanism may be a rail. The method may also include a step of guiding the food item(s) to a desired position with a guide, and may also include reducing or eliminating water on the surface of the food item(s).

In another aspect of the invention, a method of branding indicia onto an outer surface of at least one food item is described, which includes the steps of: positioning the food item(s) in a generally at a static branding station comprising a laser, and branding indicia onto the outer surface of the food item(s) with the laser. The method may also include a step of guiding the food item(s) to a desired position with a guide, and may also include reducing or eliminating water on the surface of the food item(s).

In another aspect of the invention, a method of branding indicia onto an outer surface of at least one food item is described, which generally includes the steps of marking food item(s) positioned with a rotary table. In this aspect, the method includes transferring the food item(s) from a traditional conveyor or other location to a rotary table that also optionally includes equipment that blows air directly on to the surface of the food item(s) and then positions the food item(s) on the surface of the rotary table. The method includes moving the food item(s) toward a branding station, where the food item(s) include an upper member spaced from the top surface of the conveyor, and wherein the upper member comprises an aperture: conveying food item(s) into the space between the upper member and the top surface of the conveyor: and branding indicia onto the outer surface of the food item(s) with the laser through the aperture.

In accordance with aspects described herein, cutting stations can be utilized to add a marking station for marking chicken quarters or parts by using the movement mechanism of the cutting station, moving the food item(s) in a generally horizontal direction toward a branding station comprising a laser; and branding indicia onto the outer surface of the food item(s) with the laser. The horizontal movement mechanism may be a rail. The method may also include a step of guiding the food item(s) to a desired position with a guide and reducing or eliminating water on the surface of the food item(s).

In another aspect of the invention, cone lines used to transport whole birds can be used as movement mechanism for the marking process. The method may also include a step of guiding the food item(s) to a desired position with a guide and reducing water excess in the surface of the food item.

In another aspect of the invention, a system is provided for branding indicia onto an outer surface of at least one food item, which includes a conveyor comprising a top surface and a branding station adjacent to the conveyor, the branding station comprising a laser and an upper member spaced from the top surface of the conveyor, wherein the upper member comprises an aperture adjacent to the laser. With this system, the upper member may be adjustable relative to the branding station so that the laser position can be changed relative to the top surface of the conveyor.

These and various other features and advantages will be apparent from a reading of the following detailed description.

### BRIEF DESCRIPTION OF THE DRAWINGS

Exemplary apparatuses and methods will be further explained with reference to the appended Figures, wherein like structure is referred to by like numerals throughout the several views, and wherein:

FIG. 1 is an enlarged top view of a portion of a poultry piece (e.g., a whole chicken) that was marked or branded using the equipment and methods described herein;

FIG. 2 is another enlarged top view of a portion of a poultry piece (e.g., a whole chicken) that was marked or branded using the equipment and methods described herein:

FIG. 3 is a perspective view of exemplary equipment for marking or branding food items:

FIG. 4 is a top view of the equipment illustrated in FIG. 3;

FIG. 5 is a front view of the equipment illustrated in FIG. 3:

FIG. 6 is a side view of the equipment illustrated in FIG. 3;

FIG. 7 is a perspective view of the exemplary equipment of FIG. 3 with certain portions removed to better view the frame and other underlying components:

FIG. 8 is a perspective view of the equipment of FIG. 3 with the addition of optional lateral guides and an optional safety cover or shield:

FIG. 9 is a front schematic view of exemplary equipment for marking or branding food items that are being moved along a horizontal rail:

FIG. 10 is a perspective view of a portion of exemplary equipment for marking or branding food items:

FIG. 11 is a perspective view of exemplary equipment for marking or branding food items that are moving along a horizontal rail, such as the exemplary illustrated poultry item:

FIG. 12 is a side view of the equipment illustrated in FIG. 11:

FIG. 13 is a perspective view of exemplary equipment for marking or branding food items that includes a rotary station for moving the food items:

FIG. 14 is a front view of the exemplary equipment of FIG. 13:

FIG. 15 is a front view of exemplary equipment for marking or branding food items:

FIG. 16 is a front view of exemplary equipment for marking or branding food items:

FIG. 17 is a front view of exemplary equipment for marking or branding food items; and

FIG. 18 is a side view of the exemplary equipment of FIG. 17.

FIG. 19 is a perspective view of exemplary equipment for marking or branding food items wherein the relative location of the food items is adjustable.

FIG. 20A is a front view of exemplary equipment for marking or branding food items in movement wherein the relative location of the food items is adjustable.

FIG. 20B is a perspective view of exemplary equipment for marking or branding food items in movement wherein the relative location of the food items is adjustable.

### DETAILED DESCRIPTION

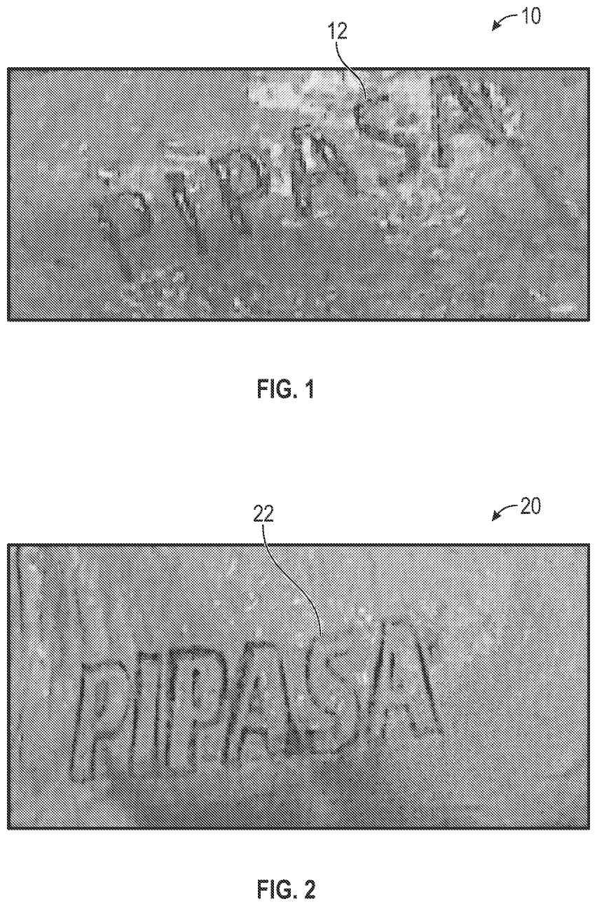

Referring now to the Figures, wherein the components are labeled with like numerals throughout the several Figures, and initially to FIG. 1, an outer surface of a portion of a poultry piece 10 is illustrated with an exemplary visible brand or mark 12. Brand or mark 12 includes a series of letters that are considered to be solid or closed in that each portion or segment of each of the letters is made up of a single line. FIG. 2 similarly illustrates an outer surface of a portion of a poultry piece 20, which includes an exemplary brand or mark 22. Brand or mark 22 includes letters, shapes, characters, logos, or other identifying information that can be considered to be open or outlined in that the outer edges of each mark is defined by a separate outer line. The inside of certain outlined marks of this format can be hollow or open, or can include one or more additional interior lines to better define the letter. For the marking illustrated in FIG. 1, the letters ‘A’ and ‘P’ each include a separate interior line within their outline to further define these letters. In embodiments, additional segments or connecting portions can be provided between adjacent marks.

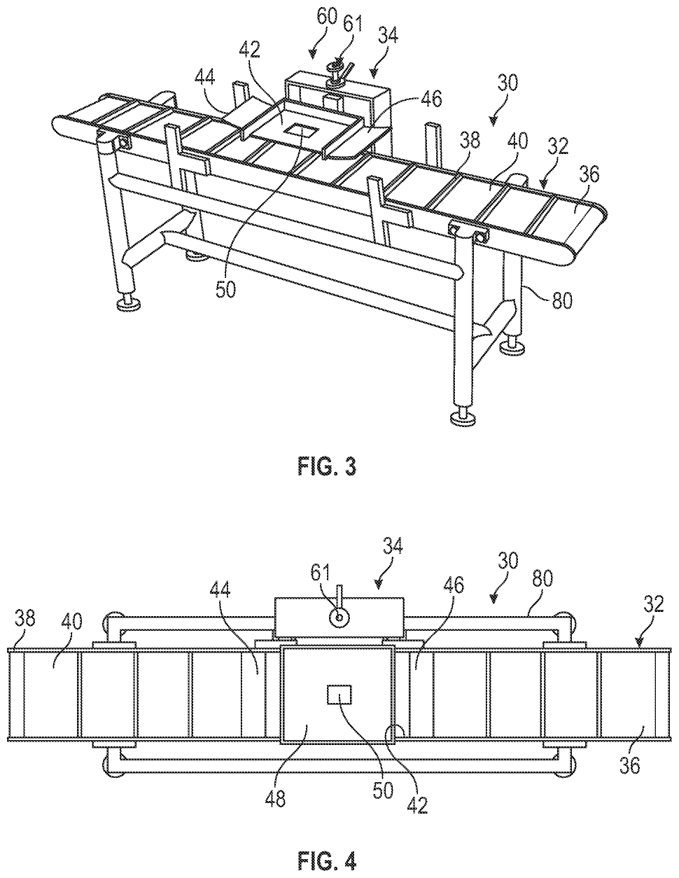

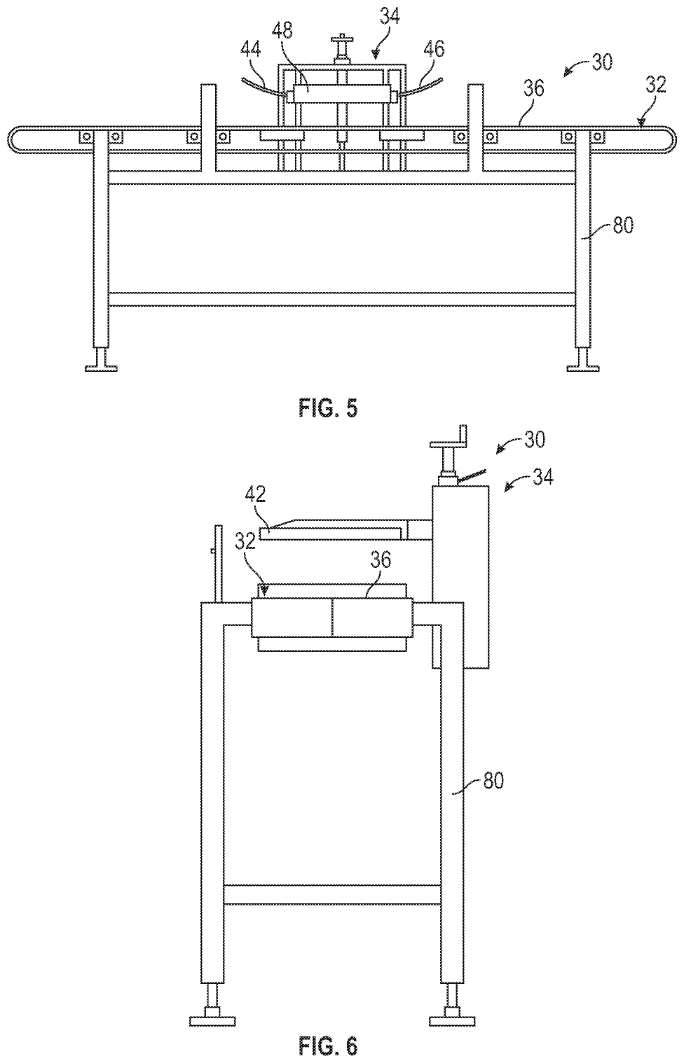

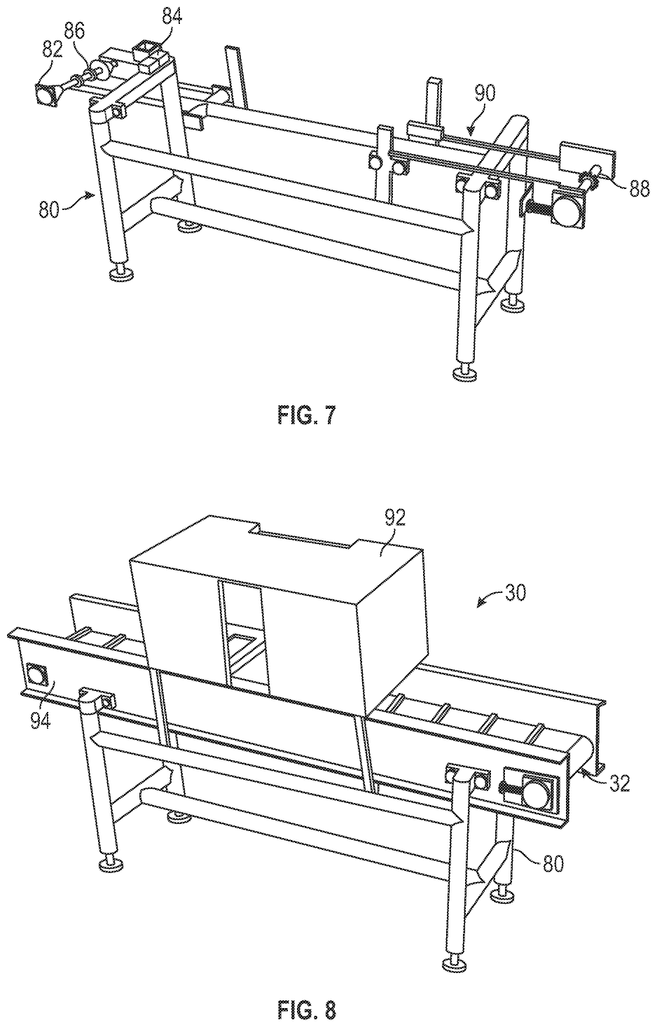

Referring now to FIGS. 3-8, various views are provided of an exemplary embodiment of processing equipment 30 for moving food items through a station or area where they are branded or marked with some type of indicia. Processing equipment 30 generally includes a horizontal conveyor 32 supported on a frame 80. Frame 80 may include a number of horizontal, vertical, and angled frame members, as desired, to support the conveyor 30 and other processing components. Frame 80 is best illustrated in FIG. 7, which provides support for a bearing 82, a traction motor 84, a traction shaft 86 at one end, and an induced shaft with belt tensioner 88 and support guides 90 at the opposite end.

Conveyor 32 is configured to facilitate movement of food items through a branding station 34. Conveyor 32 includes a horizontal top surface 36 onto which food items can be placed, and can optionally include dividers 38 spaced along the conveyor length. One embodiment of such dividers 38 includes elongated members that extend upwardly at least slightly from the horizontal top surface 36 and across all or at least a part of the width of the conveyer 32. Other configurations for dividers or markers can instead be used to define designated locations for the placement of food items. That is, spaces 40 that are defined along the conveyor 32 between pairs of adjacent dividers 38 provide designated locations for food items to be placed. In this way, relatively consistent spacing of food items along the conveyor 32 can be achieved so that consistent marking or branding can occur.

Branding station 34 includes an upper plate 42 spaced at a controllable distance from the top surface 36 of the conveyor 32. The plate 42 is vertically adjustable to change this spacing to accommodate food items of differing heights that are being moved along the conveyor 32 and through the branding station 34. Such a vertical adjustment of the plate 42 and/or other components of the system can be performed electronically and/or manually (such as via an adjustment knob 61, for example).

Upper plate 42 may optionally include end portions 44, 46 extending from a central portion 48. End portions 44, 46 are angled at least slightly upwardly to provide a ramp surface that can help to direct food items moving along the conveyor 32. That is, when a food item that is generally the same height as (or slightly larger than) the distance between the plate 42 and the top surface 36 of the conveyor 32 is moved along the conveyor 32 to the area of the branding station 34, it will first reach and contact one of the end portions 44, 46 of the plate 42, depending on the direction from which the food item is being conveyed. In cases where the food item is relatively compressible, one of the end portions 44, 46 will direct the food item toward the central portion 48 of the plate 42 by compressing it gradually to be the same height as the distance between the central portion 48 of the plate 42 and the top surface 36 of the conveyor 32.

The upper plate 42 further provides a guide for the focal length of a laser and as such, includes an opening or aperture 50 that can be at least as large as the brand or mark that will be added to conveyed food items. In embodiments, this opening or aperture 50 can be at least slightly larger than the brand or mark to be applied, or can be significantly larger. In other embodiments, the opening or aperture 50 can be smaller than the brand or mark to be applied. In this latter situation, the branding or marking process will involve programming such that the design can be applied during constant movement of the food items without distorting the brand or mark.

A laser marking system 60 of the branding station 34 is positionable in a location relative to this aperture 50 so that it can apply desired indicia through the aperture while the food items are being conveyed through the branding station 34. The laser marking system 60 is generally a non-contact printing method that marks or engraves indicia onto a surface, which can be particularly useful to prevent the contamination of food products that can occur with contact-based printers having print heads that would repeatedly be in contact with food items. Exemplary laser marking systems 60 that can be used for marking food items, such as poultry, with the equipment and methods described herein include laser marking machines commercially available from Videojet Technologies of Wood Dale, Illinois (e.g., the Videojet 3640 CO₂ Laser Marking Machine).

As explained above, conveyed food items that have a height greater than the distance between the plate 42 and the top surface 36 of the conveyor 32 will be compressed at least slightly when moving through the branding station 34. Such a configuration will provide consistent placement of a target surface of the food item as it passes under the aperture 50 of the upper plate 42. That is, the target surface of the food item will be generally in the same plane as the lower surface of the upper plate 42. Such a positioning can therefore be used for determining a desired placement of the laser marking system 60 relative to the surface it will be marking. As used herein, the term “target surface” refers to a surface of a food product that is to be marked or branded using laser marking systems. For chicken or other poultry items, the target surface can be the outer skin of the chicken or can be the outer meat surface in cases where the chicken is skinless.

The power of the laser and the time spent on the branding or marking process can be designed and adjusted depending on what target surface is going to be accepting the indicia. A number of other factors can be used in determining specific parameters for programming the laser marking systems, such as whether or not the food items (e.g., poultry) have been marinated, whether the food items include skin, muscle, and/or fat areas, whether the food items are warm, cold, or frozen, and the like.

In cases where the food items have a height that is less than the distance between the plate 42 and the top surface 36 of the conveyor 32, there will be a space between the top of the food item and the lower surface of the plate 42. Therefore, the target surface of the food item may not be as consistently positioned relative to the laser marking system 60. In this situation, the position of the target surface and/or the laser marking system 60 may need to be adjusted to achieve a desired spacing relative to each other during the branding or marking process.

Embodiments of the equipment described herein include adjustability features for vertically positioning the laser marking system 60 and the conveyor relative to each other to achieve a desired spacing of the laser marking system 60 from the target surface. Such adjustability may be accomplished manually with a variety of slides, rails, knobs, screws, or the like. The adjustability may also be automatically controlled with a system that includes sensors that detect the vertical positioning of the target surface, calculate movement parameters, and move the laser marking system 60 and/or the conveyor accordingly to achieve a desired spacing of the laser marking system from the target surface.

The speed at which the conveyor 32 is moving can be controllable in such a way that indicia is accurately applied to the food items moving through the branding station 34. It is possible for the conveyor to run continually so that the timing of the branding or marking is synchronized with the speed of the food item conveyance, or the conveyor can stop or pause briefly for the branding or marking of each food item that passes through the branding station 34.

In order to minimize the time required to brand or mark the food item at the branding station 34, the indicia or logo to be applied can be designed to minimize the number of lines that overlap and to simplify the design. For example, the solid or closed letters 12 of FIG. 1 are simpler and require fewer lines than the open or outlined letters 22 of FIG. 2. However, in some cases the user may desire the marking or branding to be more prominent or visible such that the time required for additional lines will be acceptable. In any case, designing the indicia or logo in such a way that it is limited to a single pass of the laser will take less time than multiple passes, although either of these scenarios may be acceptable to the user in various circumstances.

FIG. 8 illustrates additional optional features that for processing equipment 30. In particular, this embodiment illustrates a safety cover or shield 92 (e.g., an acrylic enclosure) that surrounds or partially surrounds the area where the marking or branding will take place. The cover or shield 92 may include various access panels and other openings, as desired. The processing equipment 30 may further include at least one lateral guide 94 extending along at least a portion of the length of the conveyor 32, which can aid in positioning the food items relative to the branding station 34 and other processing equipment.

The processing equipment 30 may further optionally include an air blower or air nozzles adjacent to the area where the food items exit the branding station and/or an odor extractor. Such an air blower or nozzles can be used to blow clean and compressed air to the food items in order to “dry” the surface where the laser is going to brand or mark the food items. This can result in a more clear or better defined mark on the food items.

The processing equipment 30 may also include an odor extractor that is used to minimize or eliminate possible odors that are produced by the branding or marking process. The odor extractor may be positioned within the cover or shield 92, when one is provided, and/or can be adjacent to the laser marking system 60.

In an exemplary process, a raw chicken was provided to a processing system similar to that described above relative to processing system 30 to achieve an acceptable brand or mark on the surface of the chicken. The parameters for this process are described below in Table 1. Non-limiting examples of parameters for other lasers are provided in Table 2.

TABLE 1

| Line parameters | | |
|---|---|---|
| Starting distance | 580 | mm |
| Intermediate lock | 50 | mm |
| Conveyor speed | 96 | mm/s |
| Laser angle and direction of movement | 270 | degrees |
| Focal distance | 140 | mm |
| Time per mark | | |
| Time per mark | 1.09 | s |
| Marking path | 178.73 | mm |
| Jump distance | 37.29 | mm |
| Width | 32.5 | mm |
| Height | 8 | mm |
| Parameters for other lasers | | |
| Time per mark | 0.433 | s |
| Frequency | 45000 | Hz |
| Pitch | 98 | mm |
| Duty | 30 | % |
| Mark speed | 1750 | (mm/s) |
| Jump speed | 10000 | (mm/s) |
| Off delay | 120 | μs |
| On delay | 70 | μs |
| Jump delay | 120 | μs |
| Mark delay | 70 | μs |
| Polygon delay | 40 | μs |

TABLE 2

| Line parameters | | |
|---|---|---|
| Starting distance | 580 | mm |
| Intermediate lock | 50 | mm |
| Conveyor speed | 96 | mm/s |
| Laser angle and direction of movement | 270 | degrees |
| Focal distance | 140 | mm |
| Time per mark | | |
| Time per mark | 0.433-1.09 | s |
| Marking path | 178.73 | mm |
| Jump distance | 37.29 | mm |
| Width | 32.5 | mm |
| Height | 8 | mm |
| Frequency | 45000 | Hz |
| Pitch | 98 | mm |
| Duty | 30 | % |
| Mark speed | 1750 | (mm/s) |
| Jump speed | 10000 | (mm/s) |
| Off delay | 120 | μs |
| On delay | 70 | μs |
| Jump delay | 120 | μs |
| Mark delay | 70 | μs |
| Polygon delay | 40 | μs |

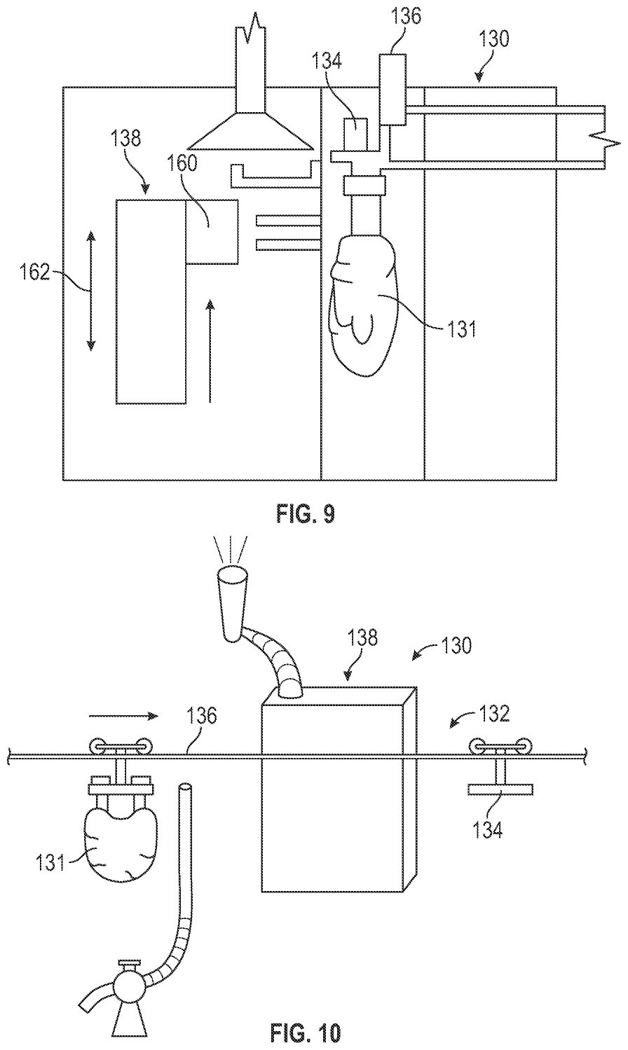

Referring now to FIGS. 9 and 10, views are provided of an exemplary embodiment of processing equipment 130 illustrating another configuration for moving food items 131 through a station or area where they are branded or marked with some type of indicia. Processing equipment 130 generally includes a rail system 132 including hooks or hangers 134. Hooks or hangers 134 can engage with food items, such as whole chickens, so that they can be moved along a rail 136 for processing, including movement through a branding station 138.

Branding station 138 includes a laser marking system 160, which is positionable in a location relative to the moving food items so that it can apply desired indicia while the food items are being moved. The laser marking system 160 can be moveable or adjustable (as is illustrated by directional arrows 162) so that it is a relatively consistent distance from the food items moving past it. In embodiments, the processing equipment 130 can include guides to control the position of the food items as they approach and are moved through the branding station 138.

The laser marking system 160 generally uses a non-contact printing method that marks or engraves indicia onto a surface, which can be particularly useful to prevent the contamination of food products that can occur with contact-based printers having print heads that are repeatedly in contact with the items on which they are printing. Exemplary laser marking systems 160 that can be used for marking food items, such as poultry, with the systems and methods described herein include laser marking machines commercially available from Videojet Technologies of Wood Dale, Illinois (e.g., the Videojet 3640 CO₂ Laser Marking Machine).

The power of the laser and the time spent on the branding or marking process can be designed and adjusted depending on what target surface is going to be accepting the indicia. A number of other factors can be used in determining specific parameters for programming the laser marking systems, such as whether or not the food items (e.g., poultry) have been marinated, whether the food items include skin, muscle, and/or fat areas, whether the food items are warm, cold, or frozen, and the like.

Embodiments of the equipment described herein include adjustability features for vertically positioning the laser marking system 160 and the rail system 132 relative to each other to achieve a desired spacing of the laser marking system 160 from the target surface. Such adjustability may be accomplished manually with a variety of slides, rails, knobs, screws, or the like. The adjustability may also be automatically controlled with a system that includes sensors that detect the vertical positioning of the target surface, calculate movement parameters, and move the laser marking system 160 and/or the rail system 132 accordingly to achieve a desired spacing of the laser marking system from the target surface.

The speed at which food items are moved along the rail system can be controllable in such a way that indicia is accurately applied to the food items moving through the branding station 138. It is possible for the rail system 132 to run continually so that the timing of the branding or marking is synchronized with the speed of the food item movement, or the rail system 132 can stop or pause briefly for the branding or marking of each food item that passes through the branding station 138.

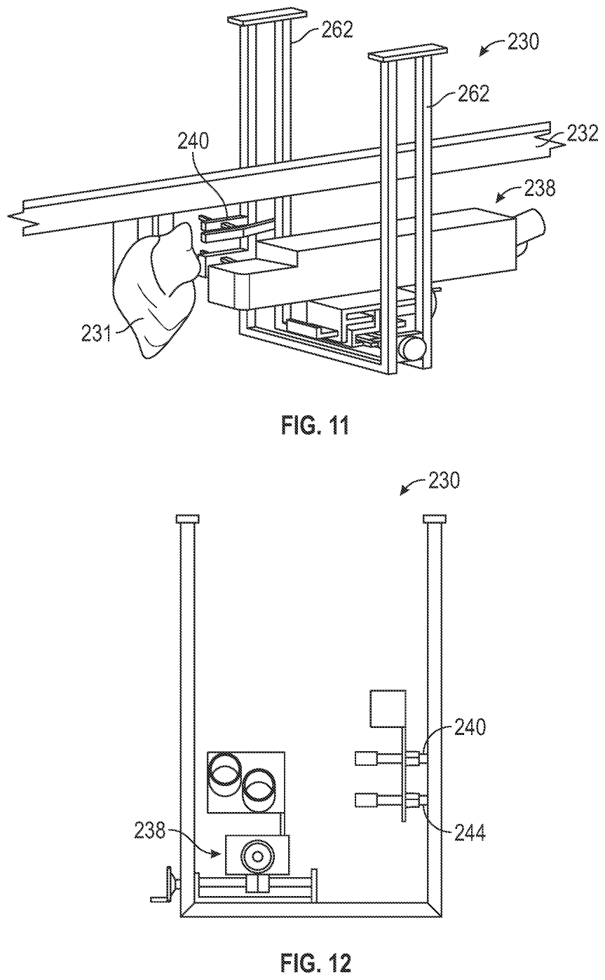

Referring now to FIGS. 11 and 12, views are provided of an exemplary embodiment of processing equipment 230 for moving food items 231 (e.g., a chicken, as illustrated) through a station or area where they are branded or marked with some type of indicia. Processing equipment 230 generally includes a rail system 232 with hooks or hangers that can engage with food items to move them along the rail system 232 for processing, including movement through a branding station 238. Guide rails or members 240 can be used for adjusting the distance between the food items 231 and the laser marking system. These guide rails or member 240 can be adjusted manually or automatically, such as via an adjustment screw 244, for example.

Branding station 238 includes a laser marking system that is positionable in a location relative to the moving food items so that it can apply desired indicia while the food items are moving. The laser marking system can be vertically and/or horizontally moveable or adjustable along laser supports 262 so that it is a relatively consistent distance from the food items moving past it. In embodiments, the processing equipment 230 can include guides to control the position of the food items as they approach and are moved through the branding station 238. As discussed above relative to other embodiments, the laser marking system is generally a non-contact printing method that marks or engraves indicia onto a surface, which can be particularly useful to prevent the contamination of food products that can occur with contact-based printers having print heads that are repeatedly in contact with the items on which they are printing

Embodiments of the equipment 230 include adjustability features for vertically positioning the branding station 238 and the rail system 232 relative to each other to achieve a desired spacing of the laser marking system from the target surface. Such adjustability may be accomplished manually with a variety of slides, rails, knobs, screws, or the like. The adjustability may also be automatically controlled with a system that includes sensors that detect the positioning of the target surface, calculate movement parameters, and move the branding station 238 and/or the rail system 232 accordingly to achieve a desired spacing of the laser marking system from the target surface.

The speed at which food items are moved along the rail system 232 can be controllable in such a way that indicia is accurately applied to the food items moving through the branding station 238. It is possible for hooks or other food holding mechanisms of the rail system 232 to run continually so that the timing of the branding or marking is synchronized with the speed of the food item movement, or components of the rail system 232 can stop or pause briefly for the branding or marking of each food item that passes through the branding station 238.

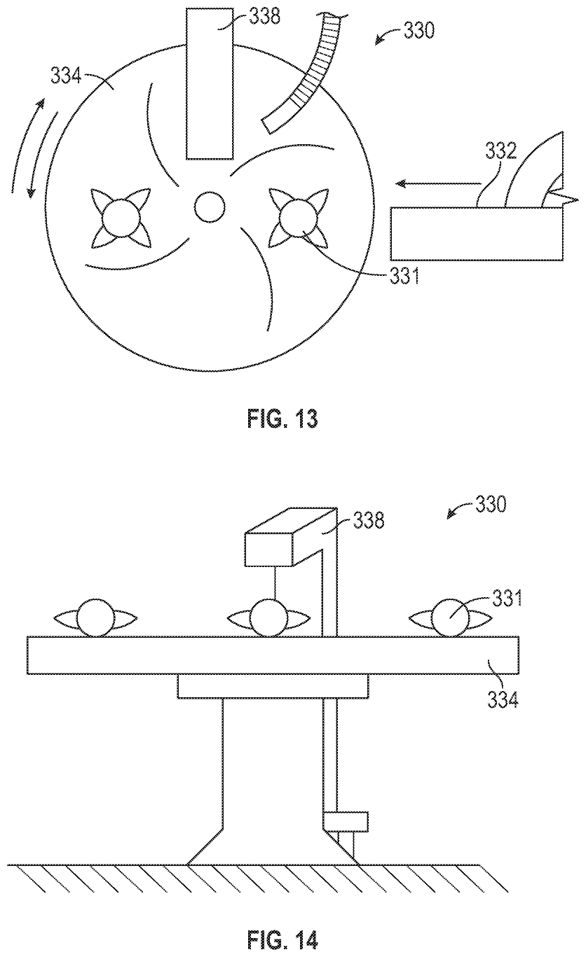

Referring now to FIGS. 13 and 14, views are provided of an exemplary embodiment of processing equipment 330 for moving food items 331 (e.g., poultry, as illustrated) through a station or area where they are branded or marked with some type of indicia. Processing equipment 330 generally includes an infeed conveyor 332 that moves food items 331 to a rotary table 334. The rotary table 344 moves food items 331 along a circular path for processing, including movement through a branding station 338.

Branding station 338 includes a laser marking system that is positionable in a location relative to the food items moving around the rotary table 334 so that it can apply desired indicia while the food items are adjacent to it. The laser marking system can be vertically and/or horizontally moveable or adjustable along laser supports so that it is a relatively consistent distance from the food items moving past it. In embodiments, the processing equipment 330 can include guides to control the position of the food items as they approach and are moved through the branding station 338. As discussed above relative to other embodiments, the laser marking system is generally a non-contact printing method that marks or engraves indicia onto a surface.

Embodiments of the equipment 330 include adjustability features for vertically positioning the branding station 338 and the rotary table 334 relative to each other to achieve a desired spacing of the laser marking system from the target branding or marking surface. Such adjustability may be accomplished manually with a variety of slides, rails, knobs, screws, or the like. The adjustability may also be automatically controlled with a system that includes sensors that detect the positioning of the target surface, calculate movement parameters, and move the branding station 338 and/or the rotary table 334 accordingly to achieve a desired spacing of the laser marking system from the target surface.

The speed at which food items are moved around the rotary table 334 can be controllable in such a way that indicia is accurately applied to the food items moving through the branding station 338. It is possible for the rotary table 334 to run continually so that the timing of the branding or marking is synchronized with the speed of the food item movement, or the rotary table 334 can stop or pause briefly for the branding or marking of each food item that passes through the branding station 338.

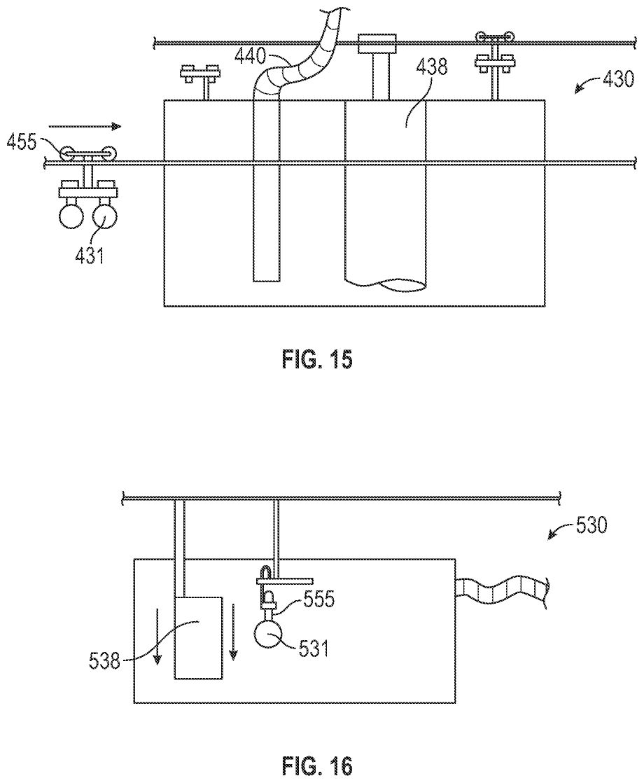

Referring now to FIGS. 15 and 16, views are provided of an exemplary embodiment of processing equipment 430, 530, respectively, for moving food items 431, 531 through a station or area where they are branded or marked with some type of indicia. In these illustrated embodiments, cut pieces or portions of a whole chicken are being processed, and as such, the equipment for handling the cut pieces will include different handling equipment than will typically be used to handle a whole chicken. Exemplary equipment that can be used for handling such cut pieces of poultry with the systems and methods described herein include the Physic Cut Up Line M3.0 that is commercially available from Meyn Food Processing Technology B.V. of Amsterdam, although other handling equipment is contemplated.

Cut food items 431, 531 are hung from attachment devices 455, 555 and moved along rails toward branding stations 438, 538, respectively. Branding stations 438, 538 each include a laser marking system that is positionable in a location relative to the food items so that it can apply desired indicia. Each laser marking system can be vertically and/or horizontally moveable or adjustable along laser supports so that it is a relatively consistent distance from the food items moving past it. In embodiments, the processing equipment 430, 530 can include guides to control the position of the food items as they approach and are moved through the branding stations 438, 538. It is possible for the attachment devices and/or rails from which the cut food items hang to run continually so that the timing of the branding or marking is synchronized with the speed of the food item movement, or the attachment devices and/or rails can stop or pause briefly for the branding or marking of each food item that passes through the branding stations 438, 538, respectively. An optional air drying station 440 may also be provided, as desired.

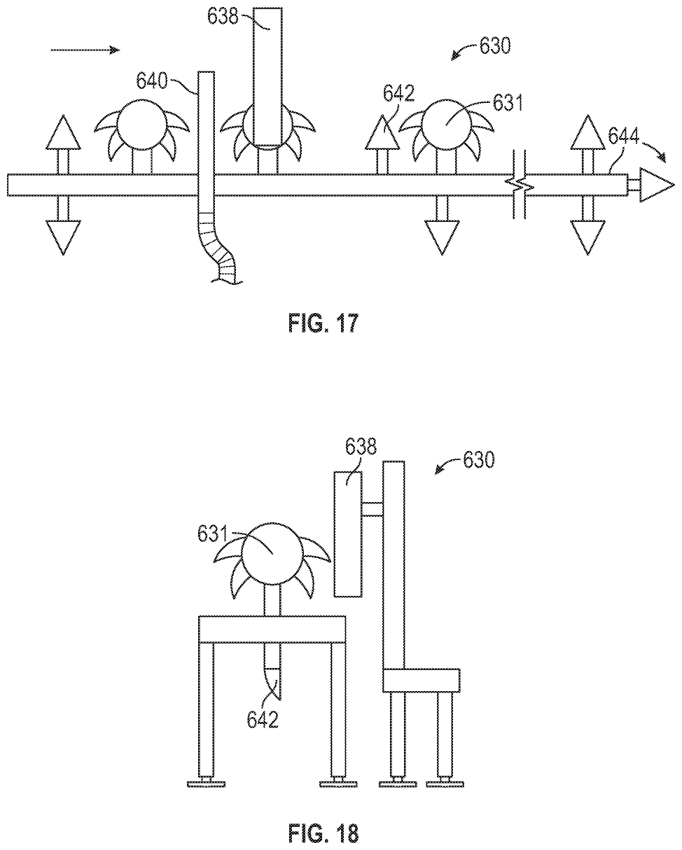

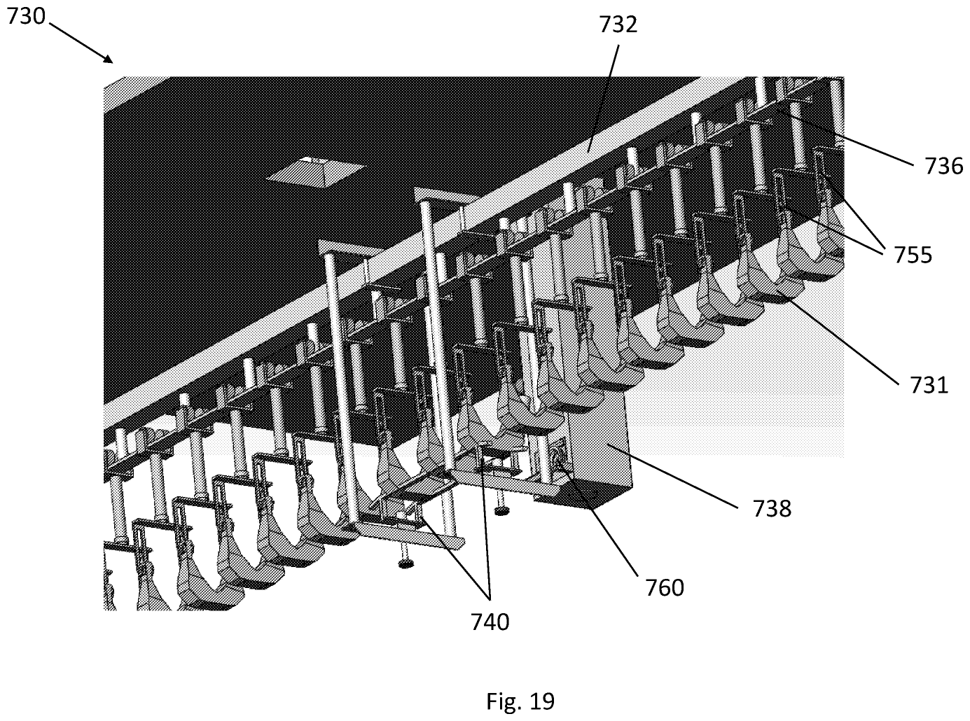

Referring now to FIGS. 17 and 18, views are provided of an exemplary embodiment of processing equipment 630 for moving food items 631 through a station or area where they are branded or marked with some type of indicia. In this illustrated embodiment, whole chickens are being processed, and as such, exemplary equipment is provided for holding and transporting a whole chicken. Equipment that can be used for handling such whole chickens or other large food items with the systems and methods described herein include multiple cones or support members 642 that extend outwardly from a conveyor 644 and support the food items 631.

Food items 631 are moved along the conveyor 644 toward a branding station 638. Branding station 638 includes a laser marking system that is positionable in a location relative to the food items so that it can apply indicia to a target surface. The laser marking system can be vertically and/or horizontally moveable or adjustable along laser supports so that it is a relatively consistent distance from the food items moving past it. It is possible for the conveyor 644 on which the whole chickens are supported to run continually so that the timing of the branding or marking is synchronized with the speed of the food item movement, or the conveyor can stop or pause briefly for the branding or marking of each food item that passes through the branding stations 638. An optional air drying station 640 may also be provided, as desired.

Referring now to FIGS. 19 to 21, views are provided of an exemplary embodiment of processing equipment 730 that can be used for moving food items 731 through a station or area where they are branded or marked with some type of indicia . . . . Referring to FIG. 19, Processing equipment 730 includes a rail system 732 including attachment devices 755. Non-limiting examples of attachment devices 755 can include hooks or hangers. Attachment devices 755 can engage with food items 731, such as whole chickens, so that they can be moved along a rail 736 for processing, including movement through a branding station 738. As discussed elsewhere herein, the laser marking system can be a non-contact printing method that marks or engraves indicia onto a surface, which can be particularly useful to prevent the contamination of food products that can occur with contact-based printers having print heads that are repeatedly in contact with the items on which they are printing

Branding station 738 includes a laser marking system 760, which has a fixed location relative to the moving food items 731. The location of moving food items 731 with respect to branding station 738 can be adjustable so that the distance between each food item 731 and laser marking system 760 is consistent at the time of marking. In embodiments, the processing equipment 730 includes guides 740 to control the position of the food items as they approach and are moved through the branding station 738. In another aspect, the location of branding station 738 can be adjustable. The adjustability of branding station 738 and/or food item(s) 731 may also be automatically controlled with a system that includes sensors that detect the positioning of the target surface, calculate movement parameters, and move the branding station 738.

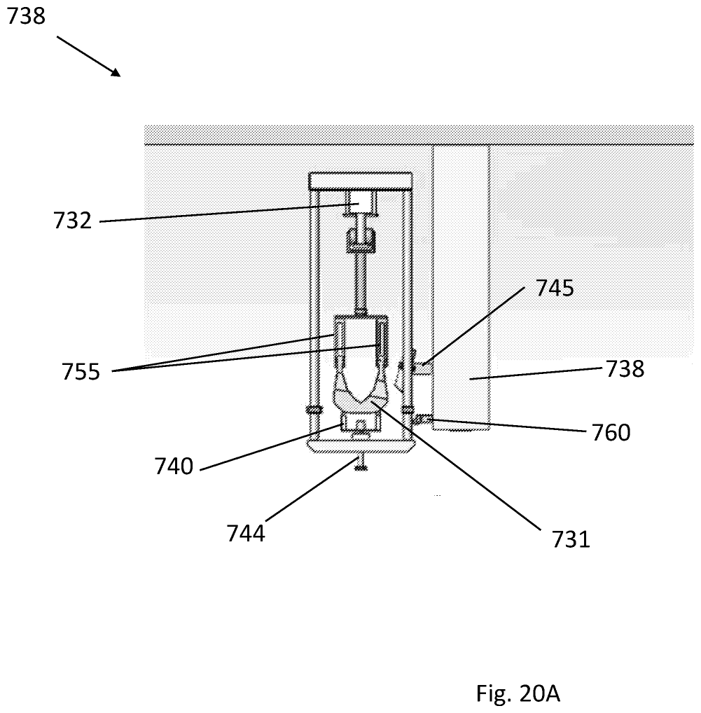

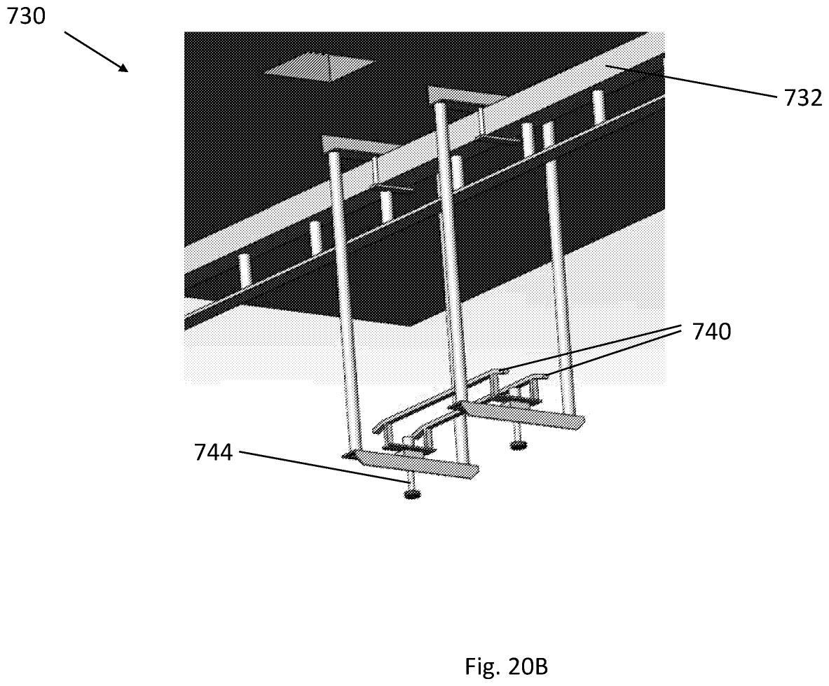

Referring now to FIGS. 20A and 20B, side and perspective views are provided of the structure of processing equipment 730. Processing equipment 730 can include a rail system 732 with attachment devices 755 connected for handling food item(s) 731, including movement through a branding station 738. Guide rails or members 740 can be used for adjusting the height of the food item 731 and/or laser marking system 760. These guide rails or member 740 can be adjusted manually or automatically, such as via an adjustment screw 744, for example. An optional airdrying station 745 may also be provided.

In FIGS. 19-20, portions of process equipment 730, including laser marking system 760, may not be shown. In an aspect, portions of laser marking system 760, or other parts of processing equipment 730 such as electronic components, can be provided in an isolated cabinet or an isolated area separated from the rest of processing equipment 730, to protect those portions of the processing equipment from humidity, dust, condensation, or other environmental contamination.

The present invention has now been described with reference to several embodiments thereof. The foregoing detailed description and examples have been given for clarity of understanding only. No unnecessary limitations are to be understood therefrom. It will be apparent to those skilled in the art that many changes can be made in the embodiments described without departing from the scope of the invention. The implementations described above and other implementations are within the scope of the following claims.

1. A method of branding indicia onto an outer surface of at least one food item, comprising the steps of:
positioning at least one food item on a top surface of a conveyor;
conveying the at least one food item toward a branding station comprising a laser, wherein the branding station comprises an upper member spaced from the top surface of the conveyor, and wherein the upper member comprises an aperture;
conveying the at least one food item into the space between the upper member and the top surface of the conveyor; and
branding indicia onto the outer surface of the at least one food item with the laser through the aperture.

2. The method of claim 1, wherein the at least one food item comprises at least one poultry item.

3. The method of claim 1, wherein the step of conveying the at least one food item further comprises conveying at a speed that allows indicia to be branded on the outer surface of the at least one food item without stopping.

4. The method of claim 1, wherein the step of conveying the at least one food item further comprises periodically pausing the conveyor to allow indicia to be branded on the outer surface of the at least one food item.

5. The method of claim 1, wherein the positioning step comprises positioning each of the at least one food items in a predetermined location on the top surface of the conveyor.

6. The method of claim 1, further comprising a step of determining a height of each food item and then adjusting the position of the upper member of the branding station relative to the outer surface of the food item prior to branding indicia onto the outer surface.

7. The method of claim 1, further comprising a step of drying the outer surface of the at least one food item prior to the step of branding indicia onto the outer surface of the at least one food item.

8. The method of claim 1, wherein the at least one food item is conveyed continuously through the branding station.

9. The method of claim 1, further comprising a step of adjusting the space between the upper member and the top surface of the conveyor.

10. The method of claim 9, wherein the space is adjusted manually.

11. The method of claim 9, wherein the space is adjusted automatically.

12. A method of branding indicia onto an outer surface of at least one food item, comprising the steps of:
attaching at least one food item to a horizontal movement mechanism;
moving the at least one food item in a generally horizontal direction toward a branding station comprising a laser; and
branding indicia onto the outer surface of the at least one food item with the laser.

13. The method of claim 12, wherein the horizontal movement mechanism comprises a rail.

14. The method of any of claim 12, further comprising a step of guiding the at least one food item to a desired position with at least one guide.

15. The method of claim 12, further comprising a step of drying the outer surface of the at least one food item prior to the step of branding indicia onto the outer surface of the at least one food item.

16. A system for branding indicia onto an outer surface of at least one food item, the system comprising:
a conveyor comprising a top surface; and
a branding station adjacent to the conveyor, the branding station comprising a laser and an upper member spaced from the top surface of the conveyor;
wherein the upper member comprises an aperture adjacent to the laser and is adjustable relative to the branding station so that the laser position can be changed relative to the top surface of the conveyor.

17. (canceled)
